(19) United States
(12) Patent Application Publication
(10) Pub. No.: US 2017/0255620 A1
(43) Pub. Date: Sep. 7, 2017

(54) SYSTEM AND METHOD FOR DETERMINING PARAMETERS BASED ON MULTIMEDIA CONTENT

(71) Applicant: Cortica, Ltd., Tel Aviv (IL)

(72) Inventors: Igal Raichelgauz, Tel Aviv (IL); Karina Odinaev, Tel Aviv (IL); Yehoshua Y Zeevi, Haifa (IL)

(73) Assignee: Cortica, Ltd., TEL AVIV (IL)

(21) Appl. No.: 15/602,669

(22) Filed: May 23, 2017

Related U.S. Application Data
(63) Continuation-in-part of application No. 15/206,792, filed on Jul. 11, 2016.
Application No. 15/206,792 is a continuation-in-part of application No. 14/509,558, filed on Oct. 8, 2014, now Pat. No. 9,575,969.
Application No. 14/509,558 is a continuation of application No. 13/602,858, filed on Sep. 4, 2012, now Pat. No. 8,868,619.
Application No. 13/602,858 is a continuation of application No. 12/603,123, filed on Oct. 21, 2009, now Pat. No. 8,266,185.
Application No. 12/603,123 is a continuation-in-part of application No. 12/084,150, filed on Apr. 7, 2009, now Pat. No. 8,655,801.
Application No. 12/603,123 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 12/603,123 is a continuation-in-part of application No. 12/348,888, filed on Jan. 5, 2009.
Application No. 12/348,888 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/603,123 is a continuation-in-part of application No. 12/538,495, filed on Aug. 10, 2009, now Pat. No. 8,312,031.
Application No. 12/538,495 is a continuation-in-part of application No. 12/084,150, filed on Apr. 7, 2009, now Pat. No. 8,655,801.
Application No. 12/084,150 is a continuation-in-part of application No. 12/195,863, filed on Aug. 21, 2008, now Pat. No. 8,326,775.
Application No. 12/538,495 is a continuation-in-part of application No. 12/348,888, filed on Jan. 5, 2009.
(60) Provisional application No. 62/340,423, filed on May 23, 2016.
(60) Provisional application No. 62/289,187, filed on Jan. 30, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30

(52) U.S. Cl. CPC G06F 17/3002; Y10S 707/99943; G06F 17/30109; G06F 17/301; Y10S 707/99948

(57) ABSTRACT

A system and method for determining parameters based on multimedia content. The method includes generating at least one signature for at least one multimedia content element, wherein each signature represents a concept, wherein each concept is a collection of signatures and metadata describing the concept; analyzing the generated at least one signature, wherein the analysis includes matching the generated at least one signature to a plurality of other signatures; and determining, based on the analysis, at least one parameter for each multimedia content element.

### CROSS-REFERENCE TO RELATED APPLICATIONS

This application claims the benefit of U.S. Provisional Application No. 62/340,423 filed on May 23, 2016. This application is also a continuation-in-part of U.S. patent application Ser. No. 15/206,792 filed on Jul. 11, 2016, now pending, which claims the benefit of U.S. Provisional Application No. 62/289,187 filed on Jan. 30, 2016. The Ser. No. 15/206,792 application is also a continuation-in-part of U.S. patent application Ser. No. 14/509,558 filed on Oct. 8, 2014, now U.S. Pat. No. 9,575,969, which is a continuation of U.S. patent application Ser. No. 13/602,858 filed on Sep. 4, 2012, now U.S. Pat. No. 8,868,619. The Ser. No. 13/602,858 Application is a continuation of U.S. patent application Ser. No. 12/603,123 filed on Oct. 21, 2009, now U.S. Pat. No. 8,266,185. The Ser. No. 12/603,123 Application is a continuation-in-part of:

(1) U.S. patent application Ser. No. 12/084,150 having a filing date of Apr. 7, 2009, now U.S. Pat. No. 8,655,801, which is the National Stage of International Application No. PCT/IL2006/001235 filed on Oct. 26, 2006, which claims foreign priority from Israeli Application No. 171577 filed on Oct. 26, 2005, and Israeli Application No. 173409 filed on Jan. 29, 2006;

(2) U.S. patent application Ser. No. 12/195,863, filed Aug. 21, 2008, now U.S. Pat. No. 8,326,775, which claims priority under 35 USC 119 from Israeli Application No. 185414 filed on Aug. 21, 2007, and which is also a continuation-in-part of the above-referenced U.S. patent application Ser. No. 12/084,150;

(3) U.S. patent application Ser. No. 12/348,888, filed on Jan. 5, 2009, now pending, which is a CIP of the above-referenced U.S. patent application Ser. Nos. 12/084,150 and 12/195,863; and

(4) U.S. patent application Ser. No. 12/538,495 filed on Aug. 10, 2009, now U.S. Pat. No. 8,312,031, which is a CIP of the above-referenced U.S. patent application Ser. Nos. 12/084,150, 12/195,863, and 12/348,888.

All of the applications referenced above are herein incorporated by reference for all that they contain.

### TECHNICAL FIELD

The present disclosure relates generally to the analysis of multimedia content, and more specifically to determining parameters based on analysis of multimedia content elements.

### BACKGROUND

With the abundance of data made available through various means in general and the Internet and world-wide web (WWW) in particular, attracting users to content has become essential for online businesses. To effectively attract users to their content, such online businesses must be capable of recognizing and adapting to user preferences. Accordingly, there is a need to understand the preferences of users.

Existing solutions provide several tools to identify users' preferences. Some existing solutions actively require an input from the users to specify their interests. However, profiles generated for users based on their inputs may be inaccurate, as the users tend to provide only their current interests, or otherwise only provide partial information due to privacy concerns. For example, a user submitting a list of musical interests for a social media account may include only recently listened to bands or songs rather than all bands or songs the user enjoys.

Other existing solutions passively track the users' activity through particular web sites such as social networks. The disadvantage with such solutions is that typically limited information regarding the users is revealed, as users tend to provide only partial information due to privacy concerns. For example, users creating an account on Facebook® provide in most cases only the minimum information required for the creation of the account. Additional information about such users may be collected over time, but may take significant amounts of time (i.e., gathered via multiple social media or blog posts over a time period of weeks or months) to be useful for accurate identification of user preferences.

Information related to user preferences and activities may be useful for, e.g., providing appropriate content and advertisements, placing advertisements effectively, supplementing user search queries, and so on. For example, knowledge of a user's location may be utilized to supplement a query “Thai restaurants” with that location, thereby allowing for returning search results that are likely more relevant to the user's interests, namely Thai restaurants in the vicinity.

It would be therefore advantageous to provide a solution that overcomes the deficiencies of the existing solutions.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The embodiments disclosed herein include a method for determining parameters based on multimedia content. The method comprises: generating at least one signature for at least one multimedia content element, wherein each signature represents a concept, wherein each concept is a collection of signatures and metadata describing the concept; analyzing the generated at least one signature, wherein the analysis includes matching the generated at least one signature to a plurality of other signatures; and determining, based on the analysis, at least one parameter for each multimedia content element.

The embodiments disclosed herein also include a non-transitory computer readable medium having stored thereon instructions for causing a processing system to execute a process, the process comprising: generating at least one signature for at least one multimedia content element, wherein each signature represents a concept, wherein each concept is a collection of signatures and metadata describing the concept; analyzing the generated at least one signature, wherein the analysis includes matching the generated at least one signature to a plurality of other signatures; and determining, based on the analysis, at least one parameter for each multimedia content element.

The embodiments disclosed herein also include a system for determining parameters based on multimedia content. The system comprises: a processing circuitry; and a memory, wherein the memory contains instructions that, when executed by the processing circuitry, configure the system to: generate at least one signature for at least one multimedia content element, wherein each signature represents a concept, wherein each concept is a collection of signatures and metadata describing the concept; analyze the generated at least one signature, wherein the analysis includes matching the generated at least one signature to a plurality of other signatures; and determine, based on the analysis, at least one parameter for each multimedia content element.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments disclosed herein.

FIG. 2 is a flowchart illustrating a method for determining parameters based on multimedia content according to an embodiment.

FIG. 3 is a flowchart illustrating a method for analyzing a plurality of multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a flowchart illustrating a method for determining a context based on multimedia content elements according to an embodiment.

FIG. 7 is a block diagram of a parameter determination system according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some features but not to others. In general, unless otherwise indicated, singular elements may be in plural and vice versa with no loss of generality. In the drawings, like numerals refer to like parts through several views.

The disclosed embodiments include a system and method for determining parameters based on multimedia content. At least one multimedia content element to be analyzed is obtained. At least one signature is generated for each multimedia content element. The generated signatures are analyzed to determine parameters for the obtained at least one multimedia content element. In an embodiment, the analysis may include matching the generated signatures to other signatures associated with predetermined parameters, where the determined parameters include each predetermined parameter associated with one of the other signatures matching at least one of the generated signatures above a predetermined threshold. In another embodiment, the analysis may include querying a deep content classification system for at least one concept matching the generated signatures, each concept including metadata describing the concept, where the determined parameters include the metadata of each matching concept.

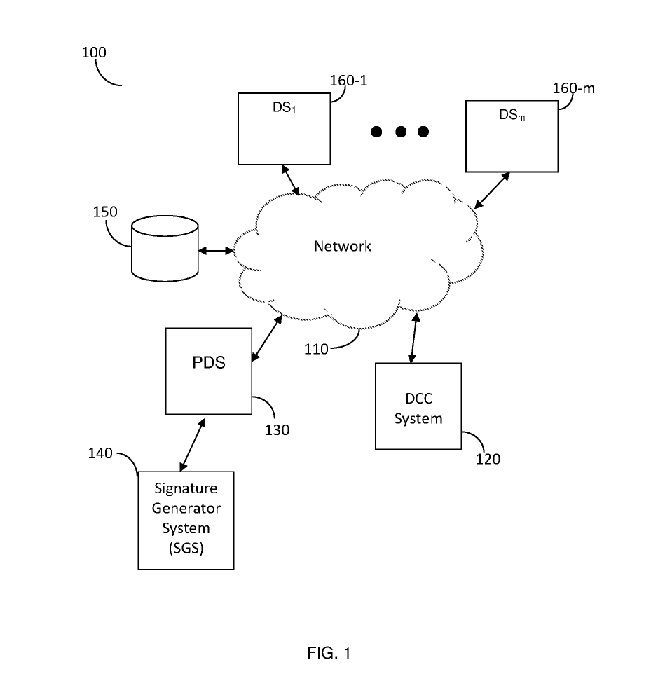

FIG. 1 shows an example network diagram 100 utilized to describe the various disclosed embodiments. The network diagram 100 includes a deep content classification (DCC) system 120, a parameter determination system (PDS) 130, a database 150, and a plurality of data sources 160-1 through 160-m (hereinafter referred to individually as a data source 160 and collectively as data sources 160, merely for simplicity purposes) communicatively connected via a network 110. The network 110 may be the Internet, the world-wide-web (WWW), a local area network (LAN), a wide area network (WAN), a metro area network (MAN), and other networks capable of enabling communication between elements of the network diagram 100.

In an embodiment, the parameter determination system 130 is further communicatively connected to a signature generator system (SGS) 140 and to the DCC system 120 through the network 110. In another embodiment, each of the DCC system 120 and the SGS 140 may be embedded in the parameter determination system 130. In a further embodiment, the SGS 140 may further include a plurality of computational cores configured for signature generation, where each computational core is at least partially statistically independent from the other computational cores.

In an embodiment, the parameter determination system 130 is configured to obtain at least one multimedia content element to be analyzed to determined parameters. With this aim, the parameter determination system 130 sends the obtained multimedia content element to the SGS 140, to the DCC system 120, or to both. The decision which is used (e.g., by the SGS 140, the DCC system 120, or both) may be a default configuration or based on the request. The multimedia content element may be stored in one of the data sources 170, received from a user device (not shown), and the like.

In an embodiment, the SGS 140 receives a multimedia content element and returns at least one signature for the received multimedia content element. For example, the multimedia content element may be retrieved from a data source 170 of a social media network. The generated signature(s) may be robust to noise and distortion. To this end, the SGS 140 may include a plurality of computational cores, where each computational core is at least partially statistically independent of the other computational cores. The process for generating the signatures is discussed in detail herein below.

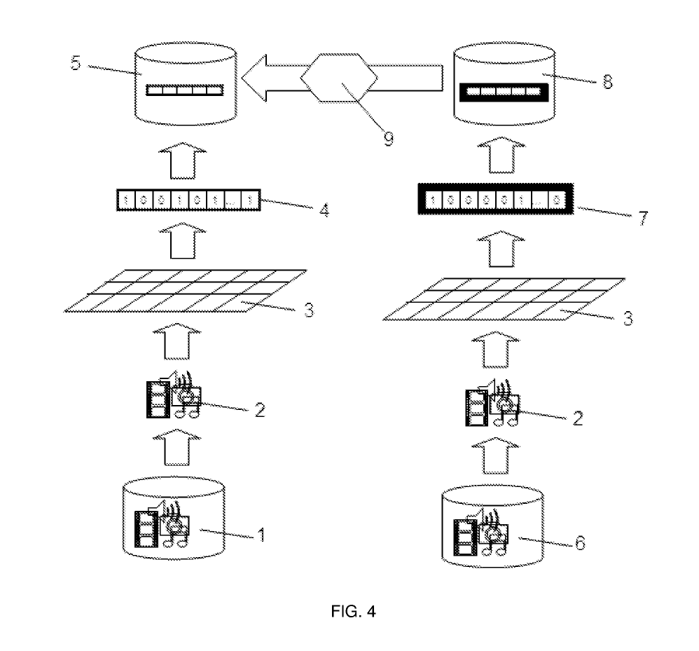

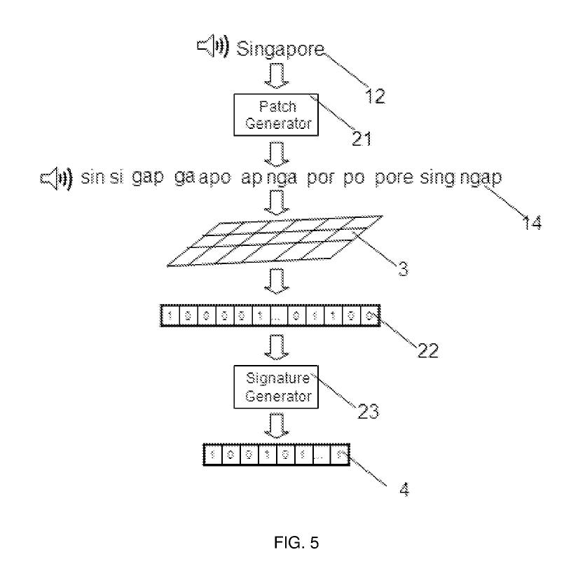

The SGS 140 may send the generated signature(s) to the parameter determination system 130. Based on the generated signature(s), the parameter determination system 130 is configured to search for similar multimedia content elements in the database 150. The process of matching between multimedia content elements is discussed in detail below with respect to FIGS. 4 and 5.

The parameter determination system 130 is configured to analyze the similar multimedia content elements found during the search with respect to the signatures in order to determine parameters. The analysis may include identification of the source in which each multimedia content element was identified. The sources from which the multimedia content elements were identified may be relevant in determining whether each multimedia content element shows the user's face or facial features.

According to another embodiment, metadata associated with each multimedia content element may by identified by the parameter determination system 130. The metadata may include, but is not limited to, a time pointer associated with the capture or upload of each multimedia content element, a location pointer associated with the capture or upload of each multimedia content element, one or more tags added to each multimedia content element, a combination thereof, and so on.

In a further embodiment, such metadata may be analyzed, and the results of the metadata analysis may be utilized to, e.g., determine whether the multimedia content element descriptive of optimally descriptive of the user's facial features. As an example, a photo taken at 11:00 PM in an outdoor park may be determined not to be optimally descriptive of a user's face or facial features. As another example, a photo associated with the tag “selfie” may be determined to be optimally descriptive of the user's facial features.

According to another embodiment, the analysis of the received multimedia content element may further be based on a concept structure (hereinafter referred to as “concept”). A concept is a collection of signatures representing elements of the unstructured data and metadata describing the concept. The concept may be a signature-reduced cluster of related signatures. As a non-limiting example, a ‘Superman concept’ is a signature-reduced cluster of signatures describing elements (e.g., multimedia elements) related to, e.g., a Superman cartoon: a set of metadata representing proving textual representation of the Superman concept. Techniques for generating concepts are also described in the above-referenced U.S. Pat. No. 8,266,185, assigned to the common assignee, which is hereby incorporated by reference for all that it contains.

According to a further embodiment, a query is sent to the DCC system 120 to match the received multimedia content element to at least one concept. The identification of a concept matching the received multimedia content element includes matching at least one signature generated for the received multimedia content element (e.g., signatures generated either by the SGS 140 or by the DCC system 120) and comparing the element's signatures to signatures representing a concept. The matching can be performed across all concepts maintained by the system DCC 160.

In an embodiment, the parameter determination system 130 is configured to determine the parameters for the obtained multimedia content elements based on the generated signatures, the determined concepts, or both. In a further embodiment, the generated signatures may be compared to signatures of multimedia content elements associated with predetermined parameters stored in the database 150 to identify at least one matching signature. In yet a further embodiment, the determined parameters include the parameters associated with each identified matching signature. To this end, in a further embodiment, the database 150 may include a list of signatures of multimedia content elements and associated predetermined parameters. In another embodiment, the determined parameters include the metadata describing each determined concept.

In an embodiment, the parameter determination system 130 is configured to store determined parameters in the database 150 for subsequent use. The stored parameters may be utilized to, e.g., identify preferences and activities of a user, create user profiles, provide appropriate content, and any other uses of personal or environmental parameters. In a further embodiment, the parameter determination system 130 may be further configured to store the generated signatures, the determined concepts, or both, in the database 150 such that each signature or concept is associated with the respective multimedia content element and, consequently, the parameters determined for the respective multimedia content element and may be utilized for subsequent determinations of parameters.

In another embodiment, the parameter determination system 130 may be configured to send the determined parameters to a user device (not shown). The sent parameters may be utilized by the user device to, e.g., replace values of variables, thereby allowing for use of the parameters to, for example, provide content (e.g., search results, applications, etc.) that is relevant to current circumstances (e.g., location, time, current user interests, etc.).

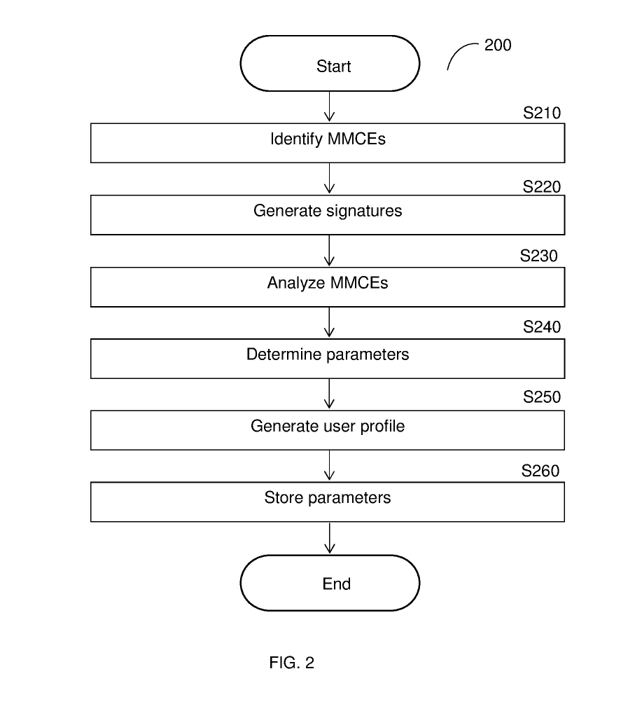

FIG. 2 depicts an example flowchart 200 illustrating a method for determining parameters based on multimedia content according to an embodiment. In an embodiment, the method may be performed by a server (e.g., the parameter determination system 130). In another embodiment, the method may be performed by an interest analyzer (e.g., the interest analyzer 125 installed on the user device 120).

At S210, at least one multimedia content element to be analyzed for parameters is obtained. The at least one multimedia content element to be analyzed may be received in a request to analyze parameters, retrieved from a data source, and the like. The request may indicate, for example, the multimedia content elements to be analyzed, at least one data source in which the multimedia content elements may be obtained, metadata tags of multimedia content elements to be analyzed, combinations thereof, and the like. The data sources may include, but are not limited to, web sources, a local storage, a combination thereof, and the like.

At S220, at least one signature is generated for each obtained multimedia content element. In an embodiment, S220 may include generating a signature for portions of any or all of the multimedia content elements. Each signature represents a concept associated with the multimedia content element. For example, a signature generated for a multimedia content element featuring a man in a costume may represent at least a “Batman®” concept. The signature(s) are generated by a signature generator (e.g., the SGS 140) as described herein below with respect to FIGS. 4 and 5.

At S230, the obtained multimedia content elements are analyzed based on the signatures. In an embodiment, S230 may include identifying multimedia content elements having signatures matching the generated signatures and associated with predetermined parameters. In another embodiment, the analysis includes determining a context of the obtained multimedia content element. In a further embodiment, the analysis includes querying a DCC system using the generated signatures for at least one matching concept wherein the matching concept represents a context.

At S240, based on the analysis of the multimedia content elements, at least one parameter is determined. In an embodiment, the determined parameters include predetermined parameters associated with signatures of multimedia content elements matching the generated signatures above a predetermined threshold. Alternatively or collectively, the determined parameters may include the metadata describing the determined matching concepts. The determined parameters may include, but are not limited to, environmental parameters indicating circumstances in which each obtained multimedia content element was captured (e.g., a location, a time, etc.), person parameters indicating information related to a particular user (e.g., interests, activities, associated people such as friends and family, etc.), or both.

As a non-limiting example, signatures of an image showing multimedia content elements of a person eating a hot dog in Central Park may be obtained compared to signatures of images associated with predetermined parameters to determine matching images showing another person eating a hot dog and characteristics of Central Park (e.g., layout of plant life, monuments or other markers, etc.) associated with an environmental parameter of “Central Park, New York City” and a personal parameter of “interest in hot dogs,” respectively. The “Central Park, New York City” and “interest in hot dogs” parameters are determined for the obtained image.

At optional S250, the determined parameters may be associated with a user profile of the user of the user device. In an embodiment, S250 includes creating a user profile and associating the determined parameters with the generated user profile. In a further embodiment, the user profiled may be generated as described further in U.S. patent application Ser. No. 15/206,711, assigned to the common assignee, which is hereby incorporated by reference for all that it contains. It should be noted that the user profile may be created in other ways without departing from the scope of the disclosure.

At S260, the determined parameters are sent for storage in a storage such as, for example, the database 150. If the determined parameters are associated with a user profile, the user profile may be stored. Alternatively or collectively, S260 may include sending the determined parameters to a user device to be utilized for, e.g., providing relevant content, applications, and the like.

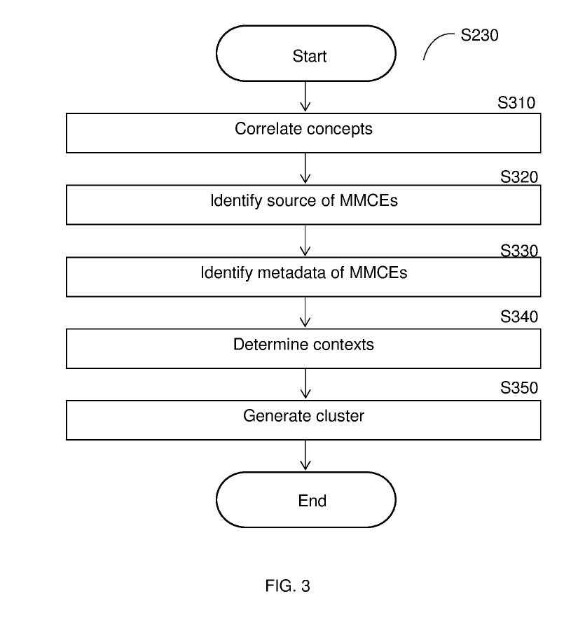

FIG. 3 depicts an example flowchart S230 illustrating a method for analyzing multimedia content elements and determining contexts of the multimedia content elements according to an embodiment. In an embodiment, the method is performed using signatures generated for the multimedia content elements by a signature generator system.

At S310, at least one concept matching the multimedia content elements is identified. In an embodiment, the concept is identified based on the signatures of the multimedia content elements. In a further embodiment, S310 may include querying a DCC system (e.g., the DCC system 120) using the signatures generated for the multimedia content elements. The metadata of the matching concept is used for correlation between a first multimedia content element and at least a second multimedia content element of the plurality of multimedia content elements.

At optional S320, a source of each multimedia content element is identified. As further described hereinabove, the source of each multimedia content element may be indicative of the content or the context of the multimedia content element. In an embodiment, S320 may further include determining, based on the source of each multimedia content element, at least one potential context of the multimedia content element. In a further embodiment, each source may be associated with a plurality of potential contexts of multimedia content elements. As a non-limiting example, for a multimedia content stored in a source including video clips of basketball games, potential contexts may include, but are not limited to, “basketball,” “the Chicago Bulls®,” “the Golden State Warriors®,” “the Cleveland Cavaliers®,” “NBA,” “WNBA,” “March Madness,” and the like.

At optional S330, metadata associated with each multimedia content element is identified. The metadata may include, for example, a time pointer associated with the capture or upload of each multimedia content element, a location pointer associated the capture or upload of each multimedia content element, one or more tags added to each multimedia content element, a combination thereof, and so on.

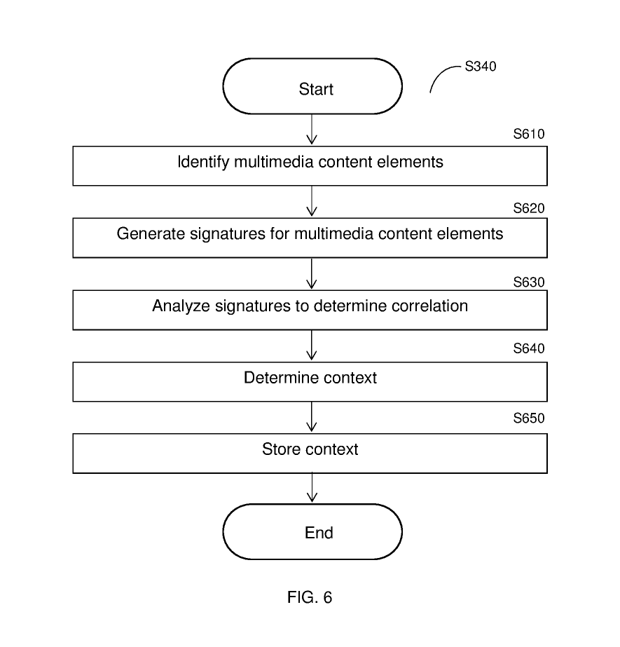

At S340, a context of the multimedia content elements is determined. In an embodiment, the context may be determined based on the correlation between a plurality of concepts related to multimedia content elements. The context may be further based on relationships between the multimedia content elements. Determining contexts of multimedia content elements based on concepts is described further herein below with respect to FIG. 6.

FIGS. 4 and 5 illustrate the generation of signatures for the multimedia content elements by the SGS 140 according to one embodiment. An example high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An example process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment, the parameter determination system 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the parameter determination system 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≦i≦L) may consist of a single leaky integrate-to-threshold unit (LTU) node or more nodes. The node ni equations are:

$${V}_{i} = {\sum }_{j} {w}_{ij} {k}_{j}$$

$${n}_{i} = θ ( Vi \text{-} {Th}_{x} )$$

where, θ is a Heaviside step function; wᵢⱼ is a coupling node unit (CNU) between node i and image component j (for example, grayscale value of a certain pixel j); kj is an image component T (for example, grayscale value of a certain pixel j); Thx is a constant Threshold value, where ‘x’ is ‘S’ for Signature and ‘RS’ for Robust Signature; and Vi is a Coupling Node Value.

The Threshold values Thx are set differently for Signature generation and for Robust Signature generation. For example, for a certain distribution of Vi values (for the set of nodes), the thresholds for Signature (Ths) and Robust Signature (ThRs) are set apart, after optimization, according to at least one of the following criteria:

1: For: Vᵢ>Th_{RS}

1−p(V>Th_{S})−1−(1−ε)^{l}<<1

i.e., given that l nodes (cores) constitute a Robust Signature of a certain image I, the probability that not all of these I nodes will belong to the Signature of same, but noisy image, \tilde{l} is sufficiently low (according to a system's specified accuracy).

2: p(Vᵢ>Th_{RS})≈l/L

i.e., approximately l out of the total L nodes can be found to generate a Robust Signature according to the above definition.

3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference for all that they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the above-noted U.S. Pat. No. 8,655,801.

FIG. 6 is an example flowchart S340 illustrating a method for determining a context of multimedia content elements based on concepts according to an embodiment.

At S610, multimedia content elements are identified. The identified multimedia content elements may be received from, e.g., a user device, or retrieved from, e.g., a data warehouse.

At S620, at least one signature is identified for each of the multimedia content elements. In an embodiment, each signature may be generated as described further herein above with respect to FIGS. 4 and 5. It should also be noted that any of the signatures may be generated based on a portion of a multimedia content element.

At S630, the generated signatures are analyzed to determine a correlation between the signatures of the multimedia content elements or portions thereof. In an embodiment, S630 includes determining correlations between concepts of the multimedia content elements. In a further embodiment, the correlations between concepts are determined by identifying a ratio between signatures' sizes, a spatial location of each signature, and so on using probabilistic models. Each signature represents a concept and is generated for a multimedia content element. Thus, identifying, for example, the ratio of signatures' sizes may also indicate the ratio between the size of their respective multimedia elements.

At S640, based on the analysis of the generated signatures, a context of the plurality of multimedia content elements is determined. In an embodiment, it may further be determined whether the context is a strong context.

A context is determined as the correlation between a plurality of concepts. A strong context is determined when there are multiple concepts, i.e., a plurality of concepts that satisfy the same predefined condition. As an example, signatures generated for multimedia content elements of a smiling child with a Ferris wheel in the background are analyzed. The concept of the signature of the smiling child is “amusement” and the concept of a signature of the Ferris wheel is “amusement park”. The relationship between the signatures of the child and of the Ferris wheel may be further analyzed to determine that the Ferris wheel is bigger than the child. The relation analysis results in a determination that the Ferris wheel is used to entertain the child. Therefore, the determined context may be “amusement.”

According to an embodiment, one or more typically probabilistic models may be utilized to determine the correlation between signatures representing concepts. The probabilistic models determine, for example, the probability that a signature may appear in the same orientation and in the same ratio as another signature. The analysis may be further based on previously analyzed signatures.

In another embodiment, the context can be determined further based on a ratio of the sizes of the objects in the multimedia content elements and their relative spatial orientations (i.e., position, arrangement, direction, combinations thereof, and the like). For example, based on an image containing multimedia content elements related to bears having different sizes, a context may be determined as “family of bears.” As another example, based on an image containing multimedia content elements of people facing the same direction (toward a camera) and having similar sizes as well as a banner for a school saying “graduation,” a context may be determined as “graduation photograph.”

At S650, the determined context is stored in, e.g., the data warehouse 150.

As a non-limiting example, a plurality of multimedia content elements contained in an image is identified. According to this example, multimedia content elements of the singer “Adele”, “red carpet”, and a “Grammy” award are shown in the image. Signatures are generated for each of the multimedia content elements. The correlation between “Adele”, “red carpet”, and a “Grammy” award is determined with respect to the signatures and the context of the image is determined based on the correlation. According to this example, such a context may be “Adele Winning the Grammy Award”. The determined context is stored in a data warehouse.

As another non-limiting example, multimedia content elements related to objects such as a “glass”, a “cutlery”, and a “plate” are identified. Signatures are generated for the glass, cutlery, and plate multimedia content elements. The correlation between the concepts represented by the signatures is determined based on previously analyzed signatures of glasses, cutlery, and plates. According to this example, as all of the concepts related to the “glass”, the “cutlery”, and the “plate” satisfy the same predefined condition, a strong context is determined. Based on the correlation among the multimedia content elements and the relative sizes and orientations of the objects illustrated by the multimedia content elements, the context of such concepts is determined to be a “table set”.

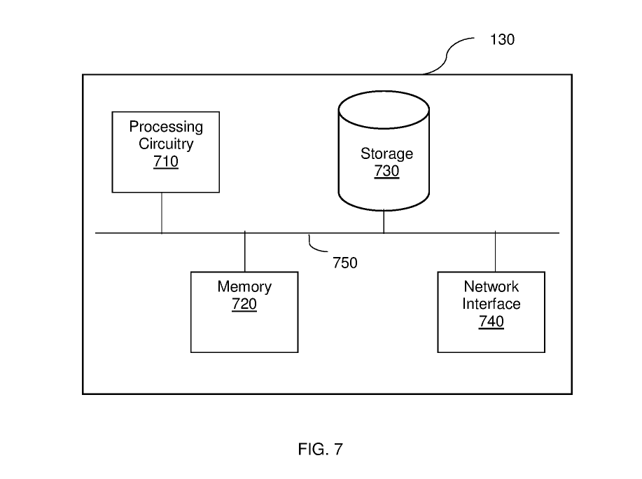

FIG. 7 is an example schematic diagram of a parameter determination system 130 according to an embodiment. The parameter determination system 130 includes a processing circuitry 710 coupled to a memory 720, a storage 730, and a network interface 740. In an embodiment, the components of the parameter determination system 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 710 may be realized as an array of at least partially statistically independent computational cores. The properties of each computational core are set independently of those of each other core, as described further herein above.

The memory 720 may be volatile (e.g., RAM, etc.), non-volatile (e.g., ROM, flash memory, etc.), or a combination thereof. In one configuration, computer readable instructions to implement one or more embodiments disclosed herein may be stored in the storage 730.

In another embodiment, the memory 720 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein. Specifically, the instructions, when executed, cause the processing circuitry 710 to determine parameters based on multimedia content as described herein.

The storage 730 may be magnetic storage, optical storage, and the like, and may be realized, for example, as flash memory or other memory technology, CD-ROM, Digital Versatile Disks (DVDs), or any other medium which can be used to store the desired information.

The network interface 740 allows the parameter determination system 130 to communicate with the signature generator system 140 for purposes such as sending multimedia content elements and receiving signatures. Further, the network interface 740 allows the parameter determination system 130 to communicate with the DCC system 120 for purposes such as sending multimedia content elements and receiving concepts. Additionally, the network interface 740 allows the parameter determination system 130 to communicate with the data sources 160, the client device 120, the database 150, or a combination thereof, for purposes such as obtaining multimedia content elements, sending determined parameters, and the like.

It should be understood that the embodiments described herein are not limited to the specific architecture illustrated in FIG. 7, and other architectures may be equally used without departing from the scope of the disclosed embodiments. In particular, the parameter determination system 130 may further include a signature generator system configured to generate signatures as described herein without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining parameters based on multimedia content, comprising:
generating at least one signature for at least one multimedia content element, wherein each signature represents a concept, wherein each concept is a collection of signatures and metadata describing the concept;
analyzing the generated at least one signature, wherein the analysis includes matching the generated at least one signature to a plurality of other signatures; and
determining, based on the analysis, at least one parameter for each multimedia content element.

2. The method of claim 1, wherein each of the plurality of other signatures is associated with at least one predetermined parameter, wherein the determined at least one parameter includes each predetermined parameter associated with one of the plurality of other signatures matching one of the generated at least one signature above a predetermined threshold.

3. The method of claim 1, wherein the analysis further comprises:
querying a deep content classification system using the generated at least one signature; and
receiving, from the deep content classification system, at least one concept matching the generated at least one signature, wherein the determined at least one parameter includes the metadata describing each matching concept.

4. The method of claim 1, further comprising:
identifying a source of each multimedia content element; and
determining, based on each identified source, a context of each of the at least one multimedia content element, wherein the analysis of the generated signatures is further based on the determined contexts.

5. The method of claim 1, further comprising:
identifying metadata associated with each multimedia content element, wherein the analysis of the generated signatures is further based on the identified metadata.

6. The method of claim 5, wherein the metadata associated with each multimedia content element includes at least one of: a time pointer associated with a capture of the multimedia content element, a time pointer associated with an upload of the multimedia content element, a location pointer associated with a capture of the multimedia content element, a location pointer associated with an upload of the multimedia content element, and a tag added to the multimedia content element.

7. The method of claim 1, wherein each multimedia content element is at least one of: an image, graphics, a video stream, a video clip, an audio stream, an audio clip, a video frame, a photograph, and an image of signals.

8. The method of claim 1, wherein each determined parameter is an environmental parameter or a personal parameter.

9. The method of claim 1, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, the properties are set independently of each other core.

10. A non-transitory computer readable medium having stored thereon instructions for causing a processing circuitry to execute a process, the process comprising:
generating at least one signature for at least one multimedia content element, wherein each signature represents a concept, wherein each concept is a collection of signatures and metadata describing the concept;
analyzing the generated at least one signature, wherein the analysis includes matching the generated at least one signature to a plurality of other signatures; and
determining, based on the analysis, at least one parameter for each multimedia content element.

11. A system for determining parameters based on multimedia content, comprising:
a processing system; and
a memory, wherein the memory contains instructions that, when executed by the processing system, configure the system to:
generate at least one signature for at least one multimedia content element, wherein each signature represents a concept, wherein each concept is a collection of signatures and metadata describing the concept;
analyze the generated at least one signature, wherein the analysis includes matching the generated at least one signature to a plurality of other signatures; and
determine, based on the analysis, at least one parameter for each multimedia content element.

12. The system of claim 11, wherein each of the plurality of other signatures is associated with at least one predetermined parameter, wherein the determined at least one parameter includes each predetermined parameter associated with one of the plurality of other signatures matching one of the generated at least one signature above a predetermined threshold.

13. The system of claim 11, wherein the system is further configured to:
query a deep content classification system using the generated at least one signature; and
receive, from the deep content classification system, at least one concept matching the generated at least one signature, wherein the determined at least one parameter includes the metadata describing each matching concept.

14. The system of claim 11, wherein the system is further configured to:
identify a source of each multimedia content element; and
determine, based on each identified source, a context of each of the at least one multimedia content element, wherein the analysis of the generated signatures is further based on the determined contexts.

15. The system of claim 11, wherein the system is further configured to:
identify metadata associated with each multimedia content element, wherein the analysis of the generated signatures is further based on the identified metadata.

16. The system of claim 15, wherein the metadata associated with each multimedia content element includes at least one of: a time pointer associated with a capture of the multimedia content element, a time pointer associated with an upload of the multimedia content element, a location pointer associated with a capture of the multimedia content element, a location pointer associated with an upload of the multimedia content element, and a tag added to the multimedia content element.

17. The system of claim 11, wherein each multimedia content element is at least one of: an image, graphics, a video stream, a video clip, an audio stream, an audio clip, a video frame, a photograph, and an image of signals.

18. The system of claim 11, wherein each determined parameter is an environmental parameter or a personal parameter.

19. The system of claim 11, wherein each signature is generated by a signature generator system, wherein the signature generator system includes a plurality of computational cores configured to receive a plurality of unstructured data elements, each computational core of the plurality of computational cores having properties that are at least partly statistically independent of other of the computational cores, the properties are set independently of each other core.

20. The system of claim 11, further comprising:
a signature generator system for generating the at least one signature, wherein the signature generator system includes a plurality of computational cores configured to receive a plurality of unstructured data elements, each computational core of the plurality of computational cores having properties that are at least partly statistically independent of other of the computational cores, the properties are set independently of each other core.
